(19) United States
(12) Patent Application Publication
(10) Pub. No.: US 2016/0114958 A1
(43) Pub. Date: Apr. 28, 2016

(54) Chemotaxis Antibacterial Film and Package

(71) Applicants: David A. Busche, Neenah, WI (US); Kevin P. Nelson, Appleton, WI (US)

(72) Inventors: David A. Busche, Neenah, WI (US); Kevin P. Nelson, Appleton, WI (US)

(21) Appl. No.: 14/522,846

(22) Filed: Oct. 24, 2014

(51) Int. Cl. B65D 81/28; A01N 25/10

(52) U.S. Cl. CPC B65D 81/28; A01N 25/10

(57) ABSTRACT

An anti-bacterial package component comprising a packaging substrate having an anti-bacterial agent fixed thereto; and a chemoattractant (bacteria attractant) incorporated with the substrate and adapted for diffusion into a food or toiletry product medium; the attractant selected from the group consisting of monosaccharides, disaccharides, polysaccharides, vitamins, minerals and essential amino acids; wherein the attractant is adapted for biological transport of pathogenic or spoilage bacteria from a product medium in contact with the substrate across an attractant concentration gradient to contact with the fixed anti-bacterial agent whereby the bacteria is killed, immobilized, made steril, or otherwise rendered harmless.

### BACKGROUND

1. Technical Field

The present application relates generally to packaging for protecting its contents from deleterious bacteria by having antibacterial properties.

2. Background Information

Packaging for food and nonfood products are available in a wide variety of sizes and shapes. For example, metal cans made from aluminum, steel and other materials are well known. Plastic and glass jars, bottles and tubs as well as plastic and paper bags including pouches, envelopes, stick packages, and the like, are all ubiquitous in modern commerce. Suitable polymeric packaging, for example, plastic monolayer or multilayer film bags, pouches, or trays should contain the product within the package while protecting the product from contamination and deleterious effects from the external environment. Thus, containers may protect their contents from contact or exposure to unwanted materials such as dirt, dust, microbes, insects, air, moisture, sunlight, and the like. Also, the materials used in constructing packaging and especially for a product such as a food (including drink) or drug, the product contact interior surface layer of the package should resist migration of chemicals between the product and the package materials. Examples of prior art packaging include U.S. Pat. Nos. 3,647,485; 4,788,075; 7,029,734; and 8,679,604.

Many commercially available food products, including meat, sausages, pudding, cheese, sour cream, condiments, and the like, are packed in packages which are manufactured using a variety of pouches, bags, trays and other containers made from thermoplastic polymers. Contamination of these products with spoilage or pathogenic bacteria is an ongoing concern and improvement in food packaging to address product safety and shelf life is an ongoing need.

Various prior art teachings disclose coating packaging surfaces with antimicrobial products which disperse into a product surface (for example, food or skin cream) upon contact with the coated package surface. Disadvantageously, such transfer of antimicrobial substances make those additives subject to regulation, quantity restrictions, potential adverse health effects, organoleptic disadvantages, and entail heightened risk analysis and labelling. To ameliorate the above disadvantages, antimicrobials have been devised which are attached to the package surface in a manner designed to prevent migration into the packaged foodstuff. These surface bound antimicrobials may be effective, but only upon physical contact and interaction with microbes. Their effectiveness is typically limited to the microbe in the immediate vicinity of the antimicrobial surface. Thus, the requirement for physical contact coupled to a requirement for non-migration of the antimicrobial operates to limit the usefulness of these prior art teachings.

### BRIEF SUMMARY

The present invention addresses the problem of limited reach of antimicrobials affixed to a packaging surface. By exploiting a microbe's natural tendency to move towards chemical attractants, the present invention significantly extends a fixed antimicrobial agent's effective range to kill, immobilize, sterilize, or otherwise render a microbe harmless and less deleterious to product safety and/or shelf life.

According to the present invention, an anti-bacterial package component is provided comprising: a packaging substrate having an anti-bacterial agent fixed thereto (=; and a bacteria attractant incorporated with the substrate and adapted for diffusion into a food or nonfood, for example, a personal care (i.e. toiletry), product medium; the attractant selected from the group consisting of monosaccharides, disaccharides, polysaccharides, vitamins, minerals and amino acids; wherein the attractant is adapted for inducing biological transport of pathogenic or spoilage bacteria from a food or nonfood medium in contact with the substrate across an attractant concentration gradient to contact with the fixed anti-bacterial agent whereby the bacteria is killed, immobilized, made sterilize, or otherwise rendered harmless.

The packaging substrate may be flexible, semi-rigid or rigid. It may be a packaging film or component, a film formed into lidstock or a bag or pouch (bag or pouch are used interchangeably herein) or any other container, a soaker pad or package insert, a semi-rigid or rigid container such as a tray, cup, bottle, or vessel of any shape that provides interfacial contact with a food or nonfood product, for example, meat, cheese, pudding, skin lotion, shampoo gel, and the like.

### BRIEF DESCRIPTION OF THE DRAWINGS

FIG. 1 is a schematic view depicting interactions between a chemotaxis antimicrobial film and a microbe contaminated foodstuff.

### DETAILED DESCRIPTION

In one aspect, the present invention provides a process for improving food or toiletry products, especially their safety, shelf life, and preservation, comprising:

(a) providing a packaging substrate;
(b) identifying a food or toiletry product having a water activity (aw) of at least 0.90; the product being susceptible to contamination by bacteria and suitable for packaging with at least 50% of its product surface area proximate a packaging substrate surface;
(c) identifying a target pathogenic or spoilage bacteria;
(d) identifying a chemoattractant selected from the group consisting of monosaccharides, disaccharides, polysaccharides, vitamins, minerals and essential amino acids for said target bacteria; the chemoattractant being scarce in the product proximate the product surface;
(e) identifying an antibacterial composition;
(f) fixing the antibacterial composition to a surface of the substrate in an amount effective to kill, immobilize, make sterilize, or otherwise render harmless the bacteria upon contact;
(g) coating the substrate with the chemoattractant in an amount sufficient to provide a concentration gradient in the product proximate the product surface for inducing bacteria transport to the substrate surface.

In one aspect the present invention seeks to provide a packaging substrate and process which promotes product safety and preservation. Packaging and methods which guard against food poisoning, exposure to disease causing bacteria as well as methods which delay or prevent food or toiletry spoilage due to microbes are provided. Product preservation keeps food safe for consumption and inhibits or prevents nutrient deterioration or organoleptic changes causing food to become less palatable and also keeps toiletries from degradation which may deleteriously affect color, odor, stability and functionality.

“Food spoilage”, as that term is used herein, includes any alteration in the condition of food which makes it less palatable including changes in taste, smell, texture or appearance. Spoiled food may or may not be toxic.

“Food poisoning”, as that term is used herein, refers to mammalian disease caused by ingestion of food contaminated by pathogenic bacteria and/or their toxins. Pathogen-contaminated food does not necessarily show any organoleptic sign of spoilage. Bacterial food poisoning may be caused by either infection of the host by the bacterial organism or by action of a toxin produced by the bacteria either in the food or in the host. There are many pathogenic or spoilage bacteria of concern with respect to food or toiletry products. The present invention may have utility with any target bacteria to enhance product preservation, and delay or prevent food spoilage, or food poisoning. Antibacterial agents affixed to the packaging substrate should be effective to kill, inhibit or prevent the growth of target bacteria such as those from the genera Escherichia; Listeria, Salmonella and Clostridium. Other target bacteria genera may include: Staphylococcus; Pseudomonas; Shigella; Klebsiella; and Bacillus.

Bacteria need water and nutrients to grow. Various products have differing amounts of water, but products having the same amount of water may have differing amounts of water that are available for use by a microorganism. It is this availability of water for use by a microorganism and not the total water content of a product that is relevant to bacterial growth. This availability may be determined by measurement of a product's water activity (a_{w}). This is true for both food and nonfood products.

The water activity of a product is the ratio between the partial vapor pressure of water in a substance and the partial vapor pressure of distilled water under identical conditions. Pure distilled water has an a_{w} of exactly one. A water activity of 0.80 (unitless) indicates that the product has a vapor pressure that is 80% of that of pure water under identical conditions. A_{w} tends to increase with temperature, but may not in some substances that contain crystalline salt or sugar. Bacteria usually require a water activity of at least 0.91 to grow. Water moves from substances of higher to lower a_{w}. A_{w} may be measured with a hygrometer.

The present invention may be used with an identified product, for example, a food or personal care (toiletry) product which should have a water activity (aw) of at least 0.910. The invention may also be applied to products having a water activity of at least 0.930 and may also be used with products having a water activity of at least 0.970. Generally, it is expected that the invention will have most applicability to products having a water activity between 0.910 to 0.990, any bacterial growth supporting water activity up to an a_{w} of one is possible. Typical water activity values at about 20-25° C. include the following (note: mixtures, recipe variation, food and toiletry compositional variations will change water activity): pancake batter (0.99); ketchup (0.933); prepared mustard (0.938); french dressing (0.924); ranch dressing (0.965); sour cream (0.994); mayonnaise (0.930); apple sauce (0.983); tomato puree (0.987); tomato paste (0.967); beef (0.990-0.992); ground beef with 8% fat, lean (0.992); lamb (0.990); liverwurst (0.972); pork (0.990); pork sausage (0.97-0.99); salami (0.968); canned sardines (0.969); tuna pate (0.951); strawberry flavored gelatin snack (0.981); Jell-O chocolate pudding snack (0.979); vanilla pudding (0.97); shampoo (0.97); conditioner (0.96); liquid soap (0.91); and skin lotion (0.98).

The identified product, for example, a food or personal care product may be a liquid that has a viscosity suitable for (1) formation and maintenance of a product concentration gradient and (2) bacteria motility across the gradient. This viscosity range is preferably at the temperature at which the package is designed to provide an antibacterial chemotaxis effect. Suitable temperatures for which package effectiveness is desired may vary in accordance with desires for effectiveness at processing, storage, shipping, display for sale, and/or at end user temperature conditions. Beneficially, a target temperature for effectiveness may be from above freezing to elevated process conditions and may include, for example, from above freezing to 5, 10, 15, 20, 25, 30, 35, 40, and 45° C. or higher or at any 1° C. interval thereof. Preferably, effectiveness at either room temperature (approximately 20-23° C.) is desired or at refrigeration conditions, for example, between 1.7 to 3.3° C.

Suitable food or personal care products may have viscosities of from about 1000 to 250,000 millipascal seconds (mPa s) also referred to as centipoise (cps), at the desired temperature for achieving the chemotaxis effect, for example, at a temperature within the range of 1.7 to 25° C., preferably at either or both room temperature (20-23° C.) or at refrigeration temperatures (1.7 to 3.3° C.). Alternatively, the food or personal care product may be substantially solid, semi-solid, or gel-like. In some embodiments, at least 50% of the product surface area is proximate a packaging substrate surface, for example, a product contact surface of a packaging substrate or substrate component. It is not necessary that the product surface be in direct or continuous contact with the product contact surface of the packaging substrate provided that the proximity of the product surface and the product contact surface of the packaging substrate allow for the transmission and movement of bacteria and diffusion of the chemoattractant.

Good food product candidates for chemotaxis antibacterial packaging include many fresh and processed meats, sausages, dairy products such as sour cream, cheeses, fruit sauces such as apple sauce, condiments such as mayonnaise, salad dressings, pudding, and the like. As used herein “pudding” means a creamy-textured food product containing milk solids, fat and starch.

Good personal care product candidates for chemotaxis antibacterial packaging include many skin care or skin contact products including skin cream, skin lotion, conditioners, moisturizers, as well as hair care products such as shampoo, conditioner, shaving gels, and the like. As used herein, the term “personal care product” means toiletries for personal hygiene or beautification such as shampoo, hair conditioners, shaving gel or cream, moisturizers, skin lotions, skin cleansers, and various skin and hair care products.

The invention also employs a chemoattractant (bacteria attractant) which is defined herein as an organic or inorganic chemical material which induces bacteria movement across a concentration gradient from areas of lower concentration to areas of higher concentration. This movement in response to a chemoattractant is termed “chemotaxis”. For example, bacteria may seek a food source such as glucose by directing their overall motion in a concentration gradient towards a higher concentration of a chemoattractant. (Chemorepellants may also be used to direct bacteria away from higher concentrations to lower concentration areas and such movement is also termed chemotaxis.)

Chemoattractants are employed by the present invention as releasable coatings on a product contact surface of a packaging substrate or substrate component, such coatings form a concentration gradient in the proximate medium of a packaged product surface. Suitable chemoattractants include bacteria nutrients such as carbohydrates including monosaccharides, disaccharides, polysaccharides, minerals, vitamins, and essential amino acids. For example, chemoattractants may include one or more of the following: monosaccharides such as glucose, fructose, galactose; disaccharides such as sucrose, lactose, polysaccharides such as starch, dextrin, carboxymethylcellulose, methylcellulose, minerals such as manganese, magnesium or iron, for example, in the form of ferric hydroxide or ferric sulfate, vitamins such as folic acid, niacin or thiamine, and amino acids such as tryptophan, phenylalanine, aspartic acid, glutamic acid, isoleucine and leucine. The chemoattractant should be selected for a combination of (i) its scarcity in the product to be packaged, and (ii) its power to attract the target bacteria.

One or more chemoattractants may be coated on a food contact surface of a substrate as a powder or liquid including, for example, as a solution or dispersion in a liquid carrier such as water, alcohol, lecithin, oil, or organic carrier. The chemoattractant may also be incorporated throughout the surface polymeric layer of the substrate, for example, using the technology taught in U.S. Pat. No. 8,647,550 which is hereby incorporated by reference in its entirety. In this method, one skilled in the art may add the chemoattractant substituting it for the additive taught in the '550 patent and without undue experimentation may modify the process as needed.

According to the invention, an antibacterial composition is fixed to a packaging substrate surface. The antibacterial composition may be any suitable for use against the target bacteria that is appropriate for the intended product to be packaged. For example, antibacterial materials must be safe for food contact and comply with food laws for commercialization. They should also be compatible with functional and legal requirements for contact, for example, with human skin for toiletries. The antibacterial agent must be able to be affixed to a polymeric packaging substrate product contact layer surface for presentation to bacteria for contact whereby bacteria are killed, immobilized, rendered sterile, or otherwise rendered harmless, for example, by binding and/or growth inhibition. Suitable means for affixing the antibacterial compound to the substrate include chemical, for example, by covalent bonds, and/or physical bonding such as that described in U.S. Patent Publication No. 2011/0217544 which is hereby incorporated by reference in its entirety.

A suitable antibacterial composition which may be attached to a wide variety of polymeric packaging substrates includes cationic amine antimicrobial compounds which include antimicrobial protonated tertiary amines and small molecule quaternary ammonium compounds. Quaternary ammonium compounds are generally considered “broad spectrum” antimicrobial cationic compounds having efficacy against both gram positive (for example, Staphylococcus sp.) and gram negative (for example, Escherichia coli) microorganisms. Thus, quaternary ammonium compounds may be bonded or otherwise fixed to packaging substrates at their surface, and should be present in amounts effective for antibacterial effect to kill bacteria upon contact. The choice of the quaternary ammonium compound is not critical, but one approved for food contact is desirable for commercial food packaging use. Typically, the compound may be selected from mono-long-chain, tri-short-chain, tetralkyl-ammonium compounds, di-long-chain, di-short-chain tetralkyl-ammonium compounds, and mixtures thereof. The chains may straight or branched. N-heterocyclic ring compounds are also considered quaternary ammonia compounds. Exemplary small molecule quaternary ammonium compounds include benzalkonium chloride and alkyl substituted derivatives thereof, di-long chain alkyl (C8-C18) quaternary ammonium compounds, cetylpyridinium halides and their derivatives, benzethonium chloride and its alkyl substituted derivatives, octenidine and compatible combinations thereof. A preferred quaternary ammonium compound is dimethyloctadecyl[3-(trimethoxysilyl)propyl]ammonium chloride (CAS: 27668-52-6) (DMOAP).

Other antibacterial agents that may be employed include silver, zinc pyrothione, natamycin, for example, grafted onto the polymeric substrate via radical reaction chemistry. Another embodiment utilizes bacteriophages covalently bonded to a film substrate as described in U.S. Pat. No. 7,981,408 which patent is hereby incorporated by reference in its entirety.

It will be appreciated that the chemoattractant in many cases may be applied to the substrate either before or after or simultaneously with the antibacterial agent.

### Definitions and Nomenclature

The term “plastic” as used herein means a synthetic polymer material which at some stage of its manufacture or processing can be shaped by flow and which comprises a major proportion (>50 wt. %) of at least noncellulosic polymer. Examples of plastics include without limitation organic thermoplastic or thermosetting polymers such as polyolefins, polyamides, polyesters, polystyrenes, polyurethanes, and the like.

As used herein with respect to packaging films, sheets, or planar container materials including plastic materials, the term “flexible” means a material having a Gurley stiffness of 500 or less in milligrams (mg) force in each of its machine direction and transverse direction.

As used herein with respect to packaging films, sheets, or planar container materials including plastic materials, the term “semi-rigid” means a material having a Gurley stiffness of greater than 500 and less than 1000 milligrams (mg) force in at least one of its machine direction and transverse direction.

As used herein with respect to packaging films, sheets, or planar container materials including plastic materials, the term “rigid” means a material having a Gurley stiffness of at least 1000 milligrams (mg) force in each of its machine direction and transverse direction.

In discussing polymers, plastic films and packaging, various acronyms are used herein and they are listed below. Also, in referring to blends of polymers a colon (:) will be used to indicate that the components to the left and right of the colon are blended. In referring to film structure, a slash “/” will be used to indicate that components to the left and right of the slash are in different layers and the relative position of components in layers may be so indicated by use of the slash to indicate layer boundaries. Acronyms and terms commonly employed herein include:

PET—polyethylene terephthalate
COC—a cyclic olefin copolymer such as ethylene norbomene copolymer
PE—Polyethylene (ethylene homopolymer and/or copolymer of a major portion of ethylene with one or more α-olefins)
LDPE—low density polyethylene
LLDPE—linear low density polyethylene
mLLDPE—metallocene catalyzed linear low density polyethylene
C₂ Cₓ—a substantially linear copolymer of ethylene and an α-olefin where “x” indicates the number of carbon atoms in the comonomer.
C₂-ethylene; C₄-butene-1; C₆-hexene-1; C₈-octene-1(α-olefin monomer)
EAO—Ethylene α-olefin copolymer
EVA—Copolymer of ethylene with vinyl acetate
EVOH—a saponified or hydrolyzed copolymer of ethylene and vinyl acetate
EAA—Copolymer of ethylene with acrylic acid
EMAA—ethylene methacrylic acid copolymer
ionomer—an ethylene-methacrylic acid copolymer whose acid groups have been neutralized partly or completely to form a salt, for example, a zinc or sodium salt
PP—polypropylene
PVC—polyvinyl chloride (also includes copolymers that contain at least 50% vinyl chloride)
PVDC—polyvinylidene chloride (also includes copolymers of vinylidene chloride, especially with vinyl chloride or methyl acrylate)

“Polyolefin” is used herein broadly to include polymers such as polyethylene, ethylene-alpha olefin copolymers (EAO), polypropylene, polybutene, ethylene copolymers having a majority amount by weight of ethylene polymerized with a lesser amount of a comonomer such as vinyl acetate, and other polymeric resins falling in the “olefin” family classification. Polyolefins may be made by a variety of processes well known in the art including batch and continuous processes using single, staged or sequential reactors, slurry, solution and fluidized bed processes and one or more catalysts including for example, heterogeneous and homogeneous systems and Ziegler, Phillips, metallocene, single site and constrained geometry catalysts to produce polymers having different combinations of properties. Such polymers may be highly branched or substantially linear and the branching, dispersity and average molecular weight may vary depending upon the parameters and processes chosen for their manufacture in accordance with the teachings of the polymer arts.

“Polyethylene” is the name for a polymer whose basic structure is characterized by the chain —(CH₂—CH₂—)ₙ. Polyethylene homopolymer is generally described as being a solid at room temperature (RT) (˜23° C.) and which has a partially amorphous phase and partially crystalline phase with a density of between 0.915 to 0.970 g/cm³. The relative crystallinity of polyethylene is known to affect its physical properties. The amorphous phase imparts flexibility and high impact strength while the crystalline phase imparts a high softening temperature and rigidity.

Unsubstituted polyethylene is generally referred to as high density homopolymer and has a crystallinity of 70 to 90 percent with a density between about 0.96 to 0.97 g/cm³. Most commercially utilized polyethylenes are not unsubstituted homopolymer but instead have C₂-C₈ alkyl groups attached to the basic chain. These substituted polyethylenes are also known as branched chain polyethylenes. Also, commercially available polyethylenes frequently include other substituent groups produced by copolymerization. Branching with alkyl groups generally reduces crystallinity, density and melting point. The density of polyethylene is recognized as being closely connected to the crystallinity. The physical properties of commercially available polyethylenes are also affected by average molecular weight and molecular weight distribution, branching length and type of substituents.

People skilled in the art generally refer to several broad categories of polymers and copolymers as “polyethylene.” Placement of a particular polymer into one of these categories of “polyethylene” is frequently based upon the density of the “polyethylene” and often by additional reference to the process by which it was made since the process often determines the degree of branching, crystallinity and density. In general, the nomenclature used is nonspecific to a compound but refers instead to a range of compositions. This range often includes both homopolymers and copolymers.

For example, “high density” polyethylene (HDPE) is ordinarily used in the art to refer to both (a) homopolymers of densities between about 0.960 to 0.970 g/cm³ and (b) copolymers of ethylene and an α-olefin (usually 1-butene or 1-hexene) which have densities between 0.940 and 0.958 g/cm³. HDPE includes polymers made with Ziegler or Phillips type catalysts and is also said to include high molecular weight “polyethylenes.” In contrast to HDPE, whose polymer chain has some branching, are “ultra high molecular weight polyethylenes” which are essentially unbranched specialty polymers having a much higher molecular weight than the high molecular weight HDPE.

Hereinafter, the term “polyethylene” will be used (unless indicated otherwise) to refer to ethylene homopolymers as well as copolymers of ethylene with α-olefins and the term will be used without regard to the presence or absence of substituent branch groups.

One type of polyethylene is “high pressure, low density polyethylene” (LDPE). LDPE is used to denominate branched homopolymers having densities between 0.915 and 0.930 g/cm³. LDPEs typically contain long branches off the main chain (often termed “backbone”).

Linear Low Density Polyethylene (LLDPE) are copolymers of ethylene with alpha-olefins having densities from 0.915 to 0.940 g/cm³. The α-olefin utilized is usually 1-butene, 1-hexene, or 1-octene and Ziegler-type catalysts are usually employed (although Phillips catalysts are also used to produce LLDPE having densities at the higher end of the range, and metallocene and other types of catalysts are also employed to produce other well-known variations of LLDPEs). An LLDPE produced with a metallocene or constrained geometry catalyst is often referred to as “mLLDPE”.

Ethylene α-olefin copolymers are copolymers having an ethylene as a major component copolymerized with one or more alpha olefins such as octene-1, hexene-, or butene-1 as a minor component. EAOs include polymers known as LLDPE, VLDPE, ULDPE, and plastomers and may be made using a variety of processes and catalysts including metallocene, single-site and constrained geometry catalysts as well as Ziegler-Natta and Phillips catalysts.

Polyethylenes may be used alone, in blends and/or with copolymers in both monolayer and multilayer films for packaging applications.

“Polypropylene” is the name for a polymer whose basic structure is characterized by the chain (C₃H₆)ₙ with several stereochemical configurations, for example, isotactic, syndiotactic and atactic in varying amounts. Polypropylene homopolymer is generally described as being a translucent solid at room temperature (RT) (˜23° C.) with a density of between 0.90 to 0.91 g/cm³. The relative crystallinity of polypropylene is known to affect its physical properties. The term “polypropylene” includes homopolymer as well as random and block copolymers. Copolymers of propylene have a propylene(propene) content of 60 wt. % or more, and often >80%, and most often >90% propylene. Polypropylene copolymers are typically copolymerized with ethylene, and have been produced with increased clarity, toughness and flexibility and a generally lower melting point. Randomly polymerized ethylene monomer may be added to polypropylene homopolymer to decrease polymer crystallinity and make a more transparent polymer.

As used herein, the term “modified” refers to a chemical derivative, for example, one having any form of anhydride functionality, such as anhydride of maleic acid, crotonic acid, citraconic acid, itaconic acid, fumaric acid, and the like, whether grafted onto a polymer, copolymerized with a polymer, or otherwise functionally associated with one or more polymers, and is also inclusive of derivatives of such functionalities, such as acids, esters, and metal salts derived therefrom. Another example of a common modification is acrylate modified polyolefins.

As used herein, terms identifying polymers, such as, for example, “polyamide” or “polypropylene,” are inclusive of not only polymers comprising repeating units derived from monomers known to polymerize to form a polymer of the named type, but are also inclusive of comonomers, as well as both unmodified and modified polymers made by, for example, derivitization of a polymer after its polymerization to add functional groups or moieties along the polymeric chain. Furthermore, terms identifying polymers are also inclusive of “blends” of such polymers. Thus, the terms “polyamide polymer” and “nylon polymer” may refer to a polyamide-containing homopolymer, a polyamide-containing copolymer or mixtures thereof.

The term “polyamide” means a high molecular weight polymer having amide linkages (—CONH—)ₙ which occur along the molecular chain, and includes “nylon” resins which are well known polymers having a multitude of uses including utility as packaging films, bags, and pouches.

The term “nylon” as used herein refers more specifically to synthetic polyamides, either aliphatic or aromatic, either in crystalline, semi-crystalline, or amorphous form characterized by the presence of the amide group —CONH. It is intended to refer to both polyamides and co-polyamides.

As used herein, “EVOH” refers to ethylene vinyl alcohol copolymer. EVOH is otherwise known as saponified or hydrolyzed ethylene vinyl acetate copolymer, and refers to a vinyl alcohol copolymer having an ethylene comonomer. EVOH is prepared by the hydrolysis (or saponification) of an ethylene-vinyl acetate copolymer. The degree of hydrolysis may be from about 50 to 100 mole percent, from about 85 to 100 mole percent, or at least 97%. It is well known that to be a highly effective oxygen barrier, the hydrolysis-saponification must be nearly complete, for example, to the extent of at least 97%. EVOH is commercially available in resin form with various percentages of ethylene and there is a direct relationship between ethylene content and melting point. For example, EVOH having an ethylene content of 38 mole % has a melting point of about 173-175° C. With increasing ethylene content, the melting point is lowered, and conversely with decreasing ethylene content, the melting point is raised. Also, EVOH polymers having increasing mole percentages of ethylene have greater gas permeabilities, while EVOH polymers having decreasing mole percentages of ethylene have lower gas permeabilities. A melting point of about 158° C. corresponds to an ethylene content of 48 mole %. A melting point of about 188° C. corresponds to an ethylene content of 29 mole %. EVOH copolymers having lower or higher ethylene contents may also be employed.

The term “ethylene norbornene copolymer” means an amorphous, transparent copolymer of ethylene with norbornene made by polymerization with a metallocene catalyst. It is a cyclic olefin copolymer (COC) and is commercially available from Topas in a variety of grades with varying properties. These commercially available COCs reportedly have high transparency and gloss, excellent moisture barrier and aroma barrier properties, a variable glass transition point between about 40 to 178° C., high stiffness, high strength, excellent biocompatibility and inertness and are easy to extrude and thermoform.

As used herein, the term “polyester” refers to synthetic homopolymers and copolymers having ester linkages between monomer units which may be formed by condensation polymerization methods. Polymers of this type are preferably semi-aromatic polyesters and more preferable, homopolymers and copolymers of poly(ethylene terephthalate), poly(ethylene isophthalate), poly(butylene terephthalate), poly(ethylene naphthalate) and blends thereof. Suitable semi-aromatic polyesters may have an intrinsic viscosity between 0.60 to 1.0 dL/g, preferably between 0.60 to 0.80 dL/g.

Suitable polyesters may be amorphous PET (APET), glycol modified PET (PETg) or oriented PET (OPET) film.

The term “adhesive layer,” or “tie layer,” refers to a layer or material placed on one or more layers to promote the adhesion of that layer to another surface.

As used herein, unless otherwise indicated, the terms “seal layer,” “sealing layer,” and the like refer to a packaging substrate layer, or layers, involved in the sealing of the film whether by use of adhesive or heat seal or any other means. In general, the sealant layer is a surface layer that is an exterior or an interior layer of any suitable thickness and provides for the sealing to itself or another layer or article. The article contact layer in the packaging of food or nonfood products is typically an interior surface seal layer.

The terms “heat seal layer” refers to a layer which is heat sealable and capable of fusion bonding by conventional indirect heating means which generate sufficient heat on at least one contact surface for conduction to the contiguous contact surface and formation of a bond interface therebetween without loss of the integrity. Preferably the article contact or heat seal layer is heat sealable to itself, but may be sealable to other objects, films or layers, for example, to a tray when used as a lidding film, or to an outer layer in a lap seal.

In all of the figures it will be appreciated that dimensions and relative sizes are not to scale but are chosen to illustrate the invention and its various aspects and features.

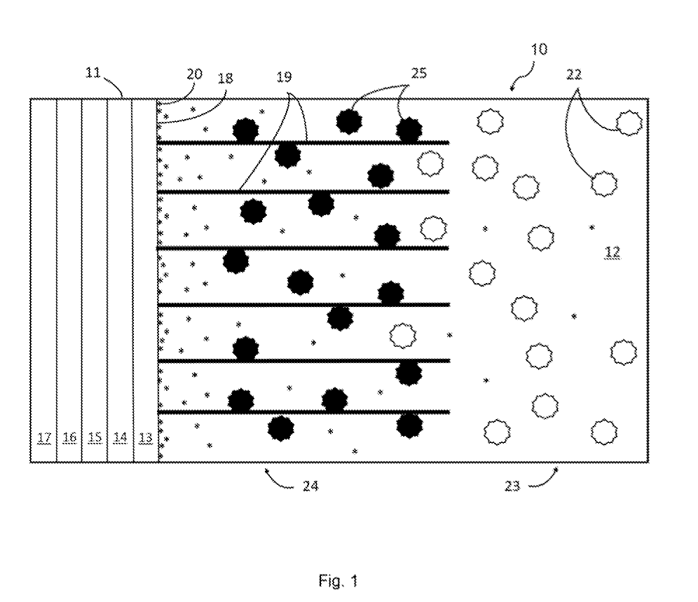

Referring now to the drawing, FIG. 1 is a schematic representation 10 of interactions between a chemotaxis antibacterial package component depicted as a packaging substrate plastic film 11 and a microbe contaminated product 12 such as a high water activity foodstuff or toiletry. Film 11 may be any suitable film for packaging the intended article and as such may comprise a single layer or multiple layers of any number and FIG. 1 illustrates a five layer film substrate 11 which has (1) a first article contact layer 13; (2) a first adhesive layer 14; (3) an oxygen barrier layer 15 of, for example, EVOH; a second adhesive layer 16; and an outer surface abuse resistant layer 17. Each of these layers may include various materials including one or more polymers such as thermoplastics, cellulosics such as regenerated cellulose or paper, metals such as aluminum foil, and the like or of combinations thereof. Any suitable substrate known to be useful for packaging may be utilized as long as it has an article contact layer 13 having a product contact surface 18 capable of fixing an antibacterial agent 19 thereto. Thus, although a five layer flexible film substrate is exemplified in FIG. 1, it will be appreciated that a rigid, semi-rigid or flexible packaging substrate may be utilized and that suitable substrates of one or more layers may be employed.

The product contact surface 18 of the plastic film 111 has fixed thereto an antimicrobial agent 19 such as (DMOAP) which is in contact with the product 12, for example, a foodstuff. A microbial chemoattractant 20 is released from surface 18 and migrates into product 12 to form a concentration gradient 21 that is proportional to the concentration of attractant with higher relative concentrations nearer to surface 18. This attractant gradient causes a movement of live active microbes 22 from an area 23 of low chemoattractant concentrations to an area 24 of higher chemoattractant concentrations where live microbes 22 are brought into contact with antibacterial agent 19 which converts live microbes 22 into post contact microbes 25 which are transformed into a less harmful state, for example, dead microbes, sterile microbes, microbes bound to the surface 18 and thereby immobilized. The microbes 23, such as bacteria, at long distances are live and potentially harmful or deleterious to food or toiletry safety and/or shelf life. As each live microbe 23 comes into contact with a moiety of the affixed antibacterial agent 19, the live active bacterium is rendered into a less harmful or less deleterious form 25, for example, by being killed. It will be appreciated that the chemoattractant 20 may be formulated to be released over time, for example, by using well known encapsulation technology, and/or be selected or compounded to be sparingly soluble to enable it to form a desired concentration gradient over the desired time frame and under the desired effective conditions, for example, of temperature, humidity, pressure, water activity, viscosity, packaged product type and product properties of viscosity, water activity, and the like.

### Film Thickness

The packaging films for the bag construction will suitably have a total thickness as found to be most desirable for the intended use. Contact with of less than about 10 mils, and beneficially a total thickness of from about 1.0 to 10 mils (25-250 microns (μ)).

### Film Layers

A package such as a bag or pouch or a package component such as a film (for example, lidstock, forming or nonforming) may have a monolayer or a multilayer film construction. Films of 1, 2, 3, 4, 5, 6, 7, 8, 9, 10, 11, 12, 13, 14, 15, 16, 17, 18 or more layers are contemplated. For some products, a monolayer film of, for example, a polyolefin such as polyethylene or polypropylene, LLDPE, or EVA, or a blend of polyolefins may be used. For other products, performance requirements may be satisfied by a two or three layer film, for example, by coupling PET with a heat sealable layer of polyolefin, or by placing an oxygen barrier polymer such as PVDC between a heat seal layer of polyolefin and an abuse resistant layer of another polyolefin. In applications for which higher performance or specific properties are desired, even more layers may be used. If multilayer, one or more layers may be employed in the aspect construction to provide the desired functionality. Alternatively, or additionally, polymers may be selected and blended to provide a layer with multiple functions in either monolayer or multilayer embodiments. Often multiple layers are utilized to provide specific functionality to the bag, although any single layer may have adequate properties for multiple functionalities.

Therefore, one or more functional properties may be contributed by one or more layers including desired levels of heat sealability, optical properties, for example, transparency, gloss, haze, abrasion resistance, coefficient of friction, tensile strength, flex crack resistance, puncture resistance, controlled rupture, abrasion resistance, printability, colorfastness, flexibility, dimensional stability, barrier properties to gases such as oxygen, or to moisture, light of broad or narrow spectrum including, for example, uv resistance, and the like.

Thus, the inventive package may use films that may include additional layers or polymers to add or modify various properties of the desired film such as heat sealability, interlayer adhesion, wrinkle resistance, flexibility, conformability, puncture resistance, printability, toughness, aroma barrier, gas and/or water barrier properties, abrasion resistance, printability, and optical properties such as clarity, transparency, haze, gloss, color, reflectivity, iridescence, luminescence, freedom from lines, streaks or gels. These layers may be formed by any suitable method including coextrusion, extrusion coating and lamination. Various types of exemplary functions and layers are described below.

### Article Contact/Heat Sealing Layers

Every packaging substrate according to the invention will have an article contact layer. A feature of the present invention is that the article contact layer have affixed thereto an antibacterial agent on its surface designed for product contact, for example, with a food or personal care product. A variety of article contact layers may be employed with the present invention and these may include, without limitation, polyolefins such as polypropylene or polyethylene, PVC, PET, nylon, and the like. The contact layer may also function as a heat sealing or heat sealable layer to facilitate formation of hermetically sealed packages. Other means of sealing such as by use of adhesives or mechanical means, for example, clips may be used instead of heat sealing or in addition thereto. The antibacterial agent is affixed to the structure of the article contact layer so that it does not easily come off or migrate to the contained product. While the antibacterial agent may be mechanically held it is preferred that it be chemically bonded to the article contact surface layer especially by covalent bonds. Examples of suitable antibacterial agents include DMOAP, silver, and zinc pyrothione.

### Barrier Layers

A primary function of packaging is to provide a barrier against admittance of various external, undesirable, physical, chemical or biological contaminants or forces. Most plastic or metal foil layers will provide barrier protection against admittance of microbes. However, often specialized layers are provided for enhanced effectiveness against particular deleterious phenomena. Thus, a specialized barrier layer may function both as a highly effective gas barrier layer, and as a moisture barrier layer, although these functions may be provided by separate layers. The gas barrier layer is typically an oxygen barrier layer since oxygen often has detrimental effects on shelf life and for certain items color, taste, or odor. Frequently, an oxygen barrier is a core layer positioned between and protected by surface layers. For example, the oxygen barrier layer can be in contact with a first surface layer and an adhesive layer or may be sandwiched between two tie layers and/or two surface layers.

In accordance with the present invention, the inventive packaging film may utilize a gas barrier layer utilizing materials such as ethylene vinyl alcohol copolymers, or polyvinylidene chloride copolymers such as saran, which provide high barriers to gas permeability. An oxygen barrier material may be selected to provide an oxygen permeability sufficiently diminished to protect the packaged article from undesirable deterioration or oxidative processes. A reduced oxygen permeability helps prevent or delay oxidation of oxygen sensitive articles and substances to be packaged in the film. For packaging oxygen sensitive products, it is desirable that the films of the present invention have an oxygen barrier transmission rate (O₂TR) of less than or equal to 20 (more desirably ≦10) cm³/100 in² per 24 hours at 1 atmosphere, 23° C. and 0% relative humidity (RH). Other polymers such as nylon may also provide a degree of oxygen barrier protection, and polyolefins work well as moisture barriers.

Advantageously, a multilayer packaging film in accordance with the present invention for packaging many oxygen sensitive products will have an oxygen barrier transmission rate (O₂TR) of less than or equal to 10 (or, optionally, ≦0.5) cm³/100 in² per 24 hours at 1 atmosphere, 23° C. and 0% relative humidity (RH).

In accordance with the present invention, the inventive packaging film may utilize a moisture barrier layer such as polyvinylidene chloride copolymers such as saran, or polyolefin materials such as LDPE which impede moisture vapor permeation. A water or moisture barrier may be selected to provide a moisture permeability sufficiently diminished to protect the packaged article from undesirable deterioration and/or retain liquid from articles without alteration of composition or loss of moisture or water content. Moisture barriers are also used to protect the functionality of other packaging materials which may be water sensitive. For example, a film may comprise a water barrier having a moisture permeability that is low enough to prevent weight loss of water by permeation through the film. It may also act to prevent undesirable interaction with contained product. In addition, it may protect a material such as EVOH which is often used as an oxygen barrier but whose oxygen properties deteriorate in the presence of water.

It is desirable that the films of the present invention have a water vapor transmission rate (WVTR) of less than 0.5 g/100 inch² per 24 hours at 100° F. and 90% relative humidity (R.H.).

In many embodiments of the present invention, suitable barrier properties may have values of WVTR less than or equal to 0.03 g/100 in²/24 hours at 38° C. and 90% R.H.; and/or O₂TR values of less than or equal to 10 cm³/100 in²/24 hours at 1 atmosphere at 23° C. and 0% R.H. In some embodiments, barrier property values are WVTR ≦0.001 g/100 in²/24 hours at 38° C. and 90% R.H., and/or O₂TR values of less than or equal to 1.0 (or optionally, ≦0.5) cm³/100 in²/24 hours, 23° C. and 0% R.H.

The oxygen and moisture barrier layer(s) may comprise any suitable material. An oxygen barrier layer can comprise EVOH, polyvinylidene chloride, polyamide, polyester, polyalkylene carbonate, polyacrylonitrile, metal foils, and the like, as known to those of skill in the art. Suitable moisture barrier layers include polyolefins such as LDPE, MDPE, HDPE, PP, or LLDPE, as well as aluminum foil, PCTFE, and PVDC.

### Bulk Layers

A bulk layer may be provided to provide additional functionality such as stiffness or heat sealability or to improve machinability, cost, flexibility, barrier properties, thermal resistance, and the like. Exemplary bulk layers comprise one or more polyolefins such as polyethylene, ethylene-alpha olefin copolymers (EAO), polypropylene, polybutene, ethylene copolymers having a majority amount by weight of ethylene polymerized with a lesser amount of a comonomer such as vinyl acetate, and other polymeric resins falling in the “olefin” family classification. The bulk layer may be of any suitable thickness from 0.1 to 7 mils or may even be omitted for use in certain applications.

### Abuse-Resistant Outer Layer

Embodiments of the invention should provide sufficient integrity to protect the contained product and provide a barrier to admittance of bacteria. The initial barrier is of course the exterior layer of the package that faces the external environment. This layer is typically abrasion and puncture resistant, and for these reasons it is often termed the abuse-resistant layer. In packaging film embodiments of the invention, this layer is also the exterior layer of a bag or other container made from the film, and is therefore subject to handling and abuse, for example, from equipment during packaging, and from rubbing against other packages, not only in the packaging process, but also during transport, storage, display and use. Surface contact with abrasive forces, stresses and pressures may abrade the film, causing defects which may diminish optical characteristics or cause punctures or breaches in the integrity of the package. Therefore, the exterior surface layer is typically made from materials chosen to be resistant to abrasive and puncture forces and other stresses and abuse which the packaging may encounter during packaging, shipping, and use. The exterior surface layer should be easy to machine (for example, be easy to feed through and be manipulated by machines, for example, for conveying, packaging, printing or as part of the container, film or bag manufacturing process). Suitable stiffness, flexibility, flex crack resistance, modulus, tensile strength, coefficient of friction, printability, and optical properties are also designed into exterior layers by suitable choice of materials. This layer may also be chosen to have characteristics suitable for creating desired heat seals, for example, by impulse sealers or may be used as a heat sealing surface in certain package embodiments, for example, using overlap seals.

The exterior surface layer thickness of a flexible packaging film is typically 0.2 to 2.0 mils. Thinner layers may be less effective for abuse resistance, but may have increased conformability. Thicker layers, be used to produce films having unique highly desirable abuse resistance properties, but may be more expensive and have less conformability.

### Intermediate Layers

An intermediate layer is any layer between the exterior layer and the interior layer of the packaging substrate and may include specialized barrier layers, tie layers, or layers having functional attributes useful for the film structure or its intended uses. Intermediate layers may be used to improve, impart or otherwise modify a multitude of characteristics: for example, printability for trap printed structures, machinability, tensile properties, flexibility, stiffness, modulus, designed delamination, tear properties, strength, elongation, optical, moisture barrier, oxygen or other gas barrier, radiation selection or barrier, for example, to ultraviolet (UV) wavelengths, and the like. Suitable intermediate layers may include: adhesives, adhesive polymers, polyolefin, oriented polyester, amorphous polyester, polyamide, nylon, or copolymers, blends or derivatives thereof, as well as metal foils. Suitable polyolefins may include: polyethylene, ethylene-alpha olefin copolymers (EAO), polypropylene, ethylene copolymers having a majority amount by weight of ethylene polymerized with a lesser amount of a comonomer such as vinyl acetate, and other polymeric resins falling in the “olefin” family classification, LDPE, HDPE, LLDPE, EAO, ionomer, EMA, EAA, modified polyolefins, for example, anhydride grafted ethylene polymers, and the like.

### Tie Layers

One type of intermediate layer is an adhesive layer, also known in the art as “tie layer,” which can be selected to promote the adherence of adjacent layers to one another in a multilayer film and prevent undesirable delamination. Multilayer films can comprise any suitable number of tie or adhesive layers of any suitable composition.

The exterior, interior, intermediate or tie layers of the bag film may be formed of any suitable plastic materials, for example, polyolefins, and in particular members of the polyethylene family such as LLDPE, VLDPE, HDPE, LDPE, ethylene vinyl ester copolymer or ethylene alkyl acrylate copolymer, polypropylenes, ethylene-propylene copolymers, ionomers, polybutylenes, alpha-olefin polymers, polyamides, nylons, polystyrenes, styrenic copolymers, for example, styrene-butadiene copolymer, polyesters, polyurethanes, polyacrylamides, anhydride-modified polymers, acrylate-modified polymers, polylactic acid polymers, cyclic olefin copolymers, or various blends of two or more of these materials.

### Additives to Layers

In addition to the addition of antimicrobial and chemoattractant to the packaging materials, various other additives may be included in the polymers utilized in one or more of the exterior, interior and intermediate or tie layers of packaging comprising the same. Exemplary additives, include, for example, processing aides, natural and synthetic colorants, pigments and dyes, conventional anti-oxidants, antiblock additives, plasticizers, acid, moisture or gas (such as oxygen) scavengers, slip agents, organoleptic agents, and mixtures thereof may be added to one or more film layers of the film or individual layers or the entire film may be free from such added ingredients. Additives and processing aids are typically used in amounts less than 10%, frequently less than 7%, and less than 5% of the layer weight. Slip agents may include one or more of fatty amides, such as, for example, stearamides and erucamides, and mineral particles, including, for example, silicates.

The films of the present invention may also provide a combination of one or more or all of the properties including low haze, high clarity and transparency, good machinability, suppleness and conformability, good mechanical strength and good barrier properties including high barriers to oxygen and water permeability. Films of the present invention may have a haze of less than 50%, less than 25%, or less than 15%. In yet further embodiments, the film is opaque or translucent.

The polymers may contain chemicals or additives in small amounts (typically under 1% by weight based on the weight of the polymer) which are present as by-products of the polymer manufacturing process or otherwise added by polymer manufacturers including for example catalyst residues, antioxidants, stabilizers, antiblock materials and the like.

### Methods of Manufacture

The packaging substrate, for example, a multilayer bag film, may be made by conventional processes. These processes to produce flexible films may include, for example, cast or blown film processes, coating lamination, adhesive lamination and conventional forming, sealing and/or cutting operations.

### Tray Construction

In the present invention, a semi-rigid or rigid tray may be also provided as long as its design provides sufficient surface to food surface proximity to achieve the intended chemotaxis antibacterial effect.

Following are examples given to further illustrate the invention, but these examples should not be taken as limiting the scope. All percentages are by weight unless indicated otherwise.

Reported properties for the bags described herein are based on the following test methods or substantially similar test methods unless noted otherwise.

A standard test method for determining the flexibility or rigidity, bending stiffness values described herein is a Gurley Stiffness test, a description of which is set forth in TAPPI Standard Test T 543 and ASTM D 6125-97. A suitable testing apparatus is a Gurley Digital Stiffness Tester: Model 4171DS1N manufactured by Teledyne Gurley (514 Fulton Street, Troy, N.Y. 12181-0088). This instrument allows the testing of a wide variety of materials through the use of various lengths and widths in combination with the use of a 5, 25, 50, or 200 gram weight placed in one of three positions on the pointer of the apparatus.

### Oxygen Gas Transmission Rate (O₂TR): ASTM D-3985-81

### Water Vapor Transmission Rate (WVTR): ASTM F 1249-90

### Gauge: ASTM D-2103

Melt Index (M.I.): ASTM D-1238, Condition E (190° C.) (except for propene-based (>50% C₃ content) polymers tested at Condition TL (230° C.))
Melting point (m.p.): ASTM D-3418, DSC with 5° C./min heating rate
Glass transition temperature T_{g} ASTM D3418
Gloss: ASTM D-2457, 60° angle

### Haze: ASTM D-1003

### Puncture: ASTM F-1306

### Stiffness: ASTM D-6125-97 or TAPPI #T543

Unless otherwise noted, the thermoplastic resins utilized in the present invention are generally commercially available in pellet form and, as generally recognized in the art, may be melt blended or mechanically mixed by well-known methods using commercially available equipment including tumblers, mixers or blenders. Also, if desired, well known additives such as processing aids, slip agents, anti-blocking agents and pigments, and mixtures thereof may be incorporated into the film or applied to one or more surfaces thereof, for example, by blending prior to extrusion, powdering, spraying, contact roller, application, and the like. Typically the resins and any desired additives are mixed and introduced to an extruder where the resins are melt plastified by heating and then transferred to an extrusion (or coextrusion) die. Extruder and die temperatures will generally depend upon the particular resin or resin containing mixtures being processed and suitable temperature ranges for commercially available resins are generally known in the art, or are provided in technical bulletins made available by resin manufacturers. Processing temperatures may vary depending upon other processing parameters chosen.

### Examples 1-7

### Example 1

### Manufacture of Chemoattractant Masterbatch

Nicotinic acid powder (obtained from Sigma Aldrich Company, LLC, St. Louis, Mo.) and ExxonMobil EXACT® 3040, an ethylene-hexene plastomer (obtained from ExxonMobil Chemical Company, Houston, Tex.) are combined to form a masterbatch using a corotating twin screw extruder. The extruder is heated to 165° C. and the nicotinic acid and EXACT 3040 are simultaneously added to the primary feed port at a combined throughput of 30 kg/hr. Selections of the nicotinic acid and VLDPE addition rates are made such that the composition of the mixture is 95% plastomer and 5% nicotinic acid by weight. The extruder screws rotate at 220 RPM to disperse the nicotinic acid powder in an ethylene-hexene plastomer matrix. The discharge of the extruder is fitted with a die of geometry appropriate for shaping the nicotinic acid-plastomer mixture into continuous strands. The strands are cooled in a water bath. At the exit of the water bath, an air knife removes some of the moisture clinging to the surface of the stands. After leaving the influence of the air knife, the strands are cut into discrete pellets by a rotating knife-style pelletizer. Those pellets are dried in a convection oven at about 50° C., packed in aluminum foil containing bags and stored for use.

### Example 2

### Manufacture of Film

A coextruded cast film is produced such that nicotinic acid from the masterbatch described in Example 1 comprises one of the exterior layers. To 1 kg of the nicotinic acid masterbatch pellets, 4 kg of ExxonMobil EXACT 3040 pellets are added and agitated to form a blend comprising 1% nicotinic acid. This pellet blend is introduced into a single screw extruder to form an exterior layer of a coextruded film. The extruder uses a 25 mm screw with a Maddock-style mixing tip. The temperature zones on the extruder are set to achieve a melt temperature of about 165° C. Two other extruders of similar construction are used to produce layers comprised of Dow 608A LDPE (obtained from Dow Chemical Company, Inc., Midland, Mich.). The extruders that process the 608A LDPE are set to achieve melt temperatures of about 200° C. The three extruders are run at 50 RPM. Each extruder's discharge enters a feed block arranged to yield a layer configuration of Dow 608A LDPE|Dow 608 A LDPE|nicotinic acid-containing plastomer. The discharge of the feedblock feeds a coat-hanger-style die. The die forms a coextruded molten film with a width of about 250 mm. The molten film is cooled on a rotating, water-chilled roll. The resultant coextruded film is wound into a roll at about 1.5 m/min.

### Example 3

### Coating Film with Antibacterial Agent

The nicotinic acid-containing surface of the film produced in Example 2 is corona discharge treated to yield a surface energy of about 44 dyne/cm. To prepare an antibacterial agent solution, 99 g of water is mixed with 1 g of 72% DMOAP (obtained from Sigma Aldrich Company, LLC, St. Louis, Mo.). This DMOAP solution is coated onto the corona discharge treated surface of the nicotinic acid-containing film using a #4 wire wound metering rod, i.e., Mayer rod. Water is removed from the applied coating with warm air. To complete polycondensation of the DMOAP, the coated film is placed into an oven for 60 minutes at 70° C. The DMOAP is affixed to the film and does not wash off.

### Comparative Example 4

### Manufacture of Film without Chemoattractant

A film is produced according to the method described in Example 2 except that no nicotinic acid is added to the exterior layer. This film, sans chemoattractant, is corona discharge treated and coated with DMOAP as described in Example 3.

The films of Example 3 and comparative Example 4 are each made into pouches which are filled with (a) dairy food such as pudding, and (b) skin lotion comprising an oil in water emulsion. Tests on samples a and b of the Examples are expected to show that bacteria migrate to the antibacterial film surface of Example 3 in a greater number than for comparative Example 4 evidencing a chemotaxis effect for Example 3 whereas no chemotaxis is seen in the comparative samples utilizing film from Example 4.

### Example 5

A packaging substrate of a monolayer film of low density polyethylene, which may optionally be surface treated by corona or plasma energy, for example, to a surface energy level of from 40 to 60 dyne/cm, is coated with DMOAP as described in Example 3. Thus, an antibacterial film is provided having DMOAP fixed to the film surface with covalent bonds. This antibacterial film is then coated with a bacteria attractant (chemoattractant) such as ferric hydroxide. The attractant coating may be applied to the antibacterial agent attached surface by contact with a transfer roller to provide a coating of a mineral attractant such as 5 wt. % of Fe(OH)₃ dispersed in a pH 2 HCl solution. The coated film is then dried and wound on a roll for subsequent use. In optional variations of this Example, the chemoattractant is coated prior to, or simultaneously with, the antibacterial agent. Also, wetting agents may be used if desired. Either or both chemoattractant and antibacterial agent may be applied by flood coating, pattern coating or may be coated in register. Thickness may be measured by ellispometry.

The chemoattractant coated, antibacterial agent fixed film is formed into a tube having a longitudinal heat seal which is filled with a food having a water activity of at least 0.910 such as pudding and this tube is sealed by two spaced apart transverse seals to form a pudding stick package.

The iron hydroxide is sparingly soluble in the pudding and slowly diffuses from the packaging substrate surface into the pudding forming a concentration gradient of iron ions. This chemoattractant gradient of iron causes bacteria to migrate from the pudding towards areas of increasing iron concentration until the bacteria comes into contact with DMOAP moieties attached to the polymeric film surface whereupon the bacteria are killed.

### Example 6

Table 1 illustrates a thirteen-layer coextruded palindromic packaging film useful in the present invention. The film web is typically formed as a blown film having seven layers which is then collapsed and moved through nip rollers applying heat and pressure to cause the interior layer of the blown film bubble to weld to itself thereby creating a thirteen layer film of a palindromic structure as represented in TABLE 1. The collapsed bubble forms a film sheet which has a total collapsed film thickness of about 3.0 mil (76.2 microns). Table 1 provides the details of the identity of the various materials present in each of the film layers, the arrangement of each of the film layers, and the relative proportions of each of the materials in each of the film layers.

TABLE 1

| Layer | | |
|---|---|---|
| Composition | % Layer | |
| Identifier | Thickness | Composition |
| A | 12.85 | 82.4% C₂C₈ LLDPE |
| | | 10.0% C₂C₈ VLDPE |
| | | 7.6% Additives |
| B | 7.55 | 80% C₂C₈ LLDPE |
| | | 20% anhydride modified LLDPE |
| C | 3.9 | 80.00% nylon 6 |
| | | 20.00% nylon 6/66 |
| D | 10.55 | 100% (wt.) EVOH (38 mol %) |
| E | 3.9 | 80.00% nylon 6 |
| | | 20.00% nylon 6/66 |
| F | 5.6 | 80% C₂C₈ LLDPE |
| | | 20% anhydride modified LLDPE |
| G | 11.2 | 100% (wt.) EVA (12% VA) |
| F | 5.6 | 80% C₂C₈ LLDPE |
| | | 20% anhydride modified LLDPE |
| E | 3.9 | 80.00% nylon 6 |
| | | 20.00% nylon 6/66 |
| D | 10.55 | 100% (wt.) EVOH (38 mol %) |
| C | 3.9 | 80.00% nylon 6 |
| | | 20.00% nylon 6/66 |
| B | 7.55 | 80% C₂C₈ LLDPE |
| | | 20% anhydride modified LLDPE |
| A | 12.85 | 82.4% C₂C₈ LLDPE |
| | | 10.0% C₂C₈ VLDPE |
| | | 7.6% Additives |

An example of a commercially available linear low-density polyethylene C₂C₆ LLDPE suitable for use in the present invention includes, but is not limited to, Dowlex® 2045G having a reported density of 0.920 g/cm³, a melt index of 1.0 dg/min., and a melting point of about 122° C., which is supplied by The Dow Chemical Company of Midland, Mich., U.S.A.

Exemplary of commercially available VLDPEs suitable for use in the present invention include, but are not limited to, the C₂C₈ family of resins, for example, Attane® NG 4701G having a reported density of 0.912 g/cm³, a melt flow index of 0.8 dg/min., which is supplied by The Dow Chemical Company of Midland, Mich., U.S.A.

Exemplary of commercially available anhydride-modified linear low-density polyethylenes (modLLDPE) suitable for use in the present invention include, but are not limited to, the BYNEL® family of resins, for example, BYNEL® 41E710 grade having a reported melt index of 2.7 dg/min. (at 190° C.), a density of 0.91 g/cm³, and a melting point of 115° C., which is supplied by E. I. du Pont de Nemours and Company, Wilmington, Del., U.S.A.

Exemplary of commercially available ethylene/vinyl alcohol copolymers suitable for use in the present invention include, but are not limited to, the SOARNOL® family of resins, for example, SOARNOL® ET3803 grade, the SOARNOL® family of resins having a reported bulk density of 0.64-0.74 g/cm³, a relative density of 1.13-1.22 g/cm³, a melting point of 164-188° C., which may be obtained from The Nippon Synthetic Chemical Industry Company, Ltd. (Nippon Gohsei), Osaka, Japan.

Exemplary of commercially available polyamides suitable for use in the present invention include, but are not limited to, the ULTRAMID® family of resins, for example, ULTRAMID® B36 nylon 6 having a melting point of 221° C. and a density of 1.13 g/cm³, and ULTRAMID® C40 nylon 6/66 having a melting point of 193° C. and a density of 1.12 g/cm³, both of which may be obtained from BASF, Mount Olive, N.J., U.S.A.

An example of commercially available ethylene vinyl acetate copolymer (EVA) includes, but is not limited to, Elvax® 3135XZ EVA having a reported vinyl acetate (VA) content of 12%, a density of 0.930 g/cm³, a melt index of 0.35 dg/min., a melting point of 95° C., which is supplied by E. I. du Pont de Nemours and Company, Wilmington, Del., U.S.A.

The films according to the present invention may be fabricated by any coextrusion method known to a person of ordinary skill in the art. The film of TABLE 1 may be manufactured by the following steps: (a) adding thermoplastic resins to extruders for extrusion into a seven-layer film; (b) heating the thermoplastic resins to form streams of melt-plastified polymers; (c) forcing the streams of melt-plastified polymers through a multi-orifice annular blown film die to form a tubular extrudate having a diameter and a hollow interior; (d) expanding the diameter of the tubular extrudate by a volume of gas entering the hollow interior via the central orifice; and (e) collapsing the expanded blown film tubular extrudate onto itself using heated nip rollers to form the final film structure. As in Example 4, the film is corona treated and coated by a mixture of DMOAP and folic acid to produce a chemotaxis antibacterial film substrate suitable for forming into a food or toiletry package.

### Example 7

Table 2 illustrates multilayer coextruded packaging films useful in the present invention. This film may be made with the addition of both silver and nicotinic acid to the surface layer using the masterbatch extruder blending method exemplified above in Example 2. Except as noted, the films made are as described above for Example 6. The film structure for Example 7 is as disclosed in Table 2. Example 7 is a seven layer asymmetrical film construction. The film of Example 7 has a thickness of 1.75 mil.

TABLE 2
Ex. 7

| Layer # | Composition | % thickness |
|---|---|---|
| 1 | 92.2% C₂C₈ VLDPE | 8 |
| | 7.2% Additives | |
| 2 | 90% C₂C₈ VLDPE | 12 |
| | 10% anhydride modified LLDPE | |
| 3 | 100% nylon 6/66 | 7 |
| 4 | 100% (wt.) EVOH (38 mol %) | 9 |
| 5 | 100% nylon 6/66 | 7 |
| 6 | 80% EVA (18% VA) | 22 |
| | 20% anhydride modified LLDPE | |
| 7 | 100% (wt.) EVA (18% VA) | 35 |

Other examples of packaging substrate structures, all of which may have suitable chemoattractants and antibacterial agents added, include: LLDPE monolayer; EVA monolayer; HDPE monolayer; PE/EVA/tie/EVOH/tie/EVA; PE/EVA/tie/EVOH/tie/EVA/PE; Ionomer/tie/EVOH/tie/Ionomer/tie/EVOH/tie/ionomer; EVA/tie/EVOH/tie/EVA/tie/EVOH/tie/EVA;

EVA/PE/COC/tie/EVOH/tie/COC/PE/EVA; EAO/tie/EVOH/tie/EVA/tie/EVOH/tie/EAO; PET/PE; PET/tie/polyolefin. Bags may also be made by sealing a plurality of webs together, for example, as a four sided pouch or to form a tube of having differing wall portion compositions. For example, a metal foil laminate such as aluminum foil/PE may be used.

### Embodiments of the Invention

1. An anti-bacterial package component comprising:
a packaging substrate having an anti-bacterial agent fixed thereto; and
a bacteria attractant incorporated with the substrate and adapted for diffusion into a food or toiletry product medium; the attractant selected from the group consisting of monosaccharides, disaccharides, polysaccharides, vitamins, minerals and amino acids; wherein the attractant is adapted for biological transport of pathogenic or spoilage bacteria from a product medium proximate the substrate across an attractant concentration gradient to contact with the fixed anti-bacterial agent whereby the bacteria is killed, immobilized, made steril, or otherwise rendered harmless.
2. A process comprising:
(a) providing a packaging substrate;
(b) identifying a food or toiletry product having a water activity of at least 0.910; the product being susceptible to surface contamination by bacteria and suitable for packaging with at least 50% of its product surface proximate a packaging substrate surface;
(c) identifying a target pathogenic or spoilage bacteria;
(d) identifying a chemoattractant selected from the group consisting of monosaccharides, disaccharides, polysaccharides, vitamins, minerals and amino acids for the target bacteria; the chemoattractant being scarce in the product;
(e) identifying an antibacterial composition;
(f) fixing the antibacterial composition to a surface of the substrate in an amount effective to kill, immobilize, make steril, or otherwise render harmless the bacteria upon contact;
(g) incorporating the chemoattractant with the substrate in an amount sufficient to provide a concentration gradient in the product for inducing bacteria transport to the substrate surface.
3. A package or process, as defined in embodiments 1-2, wherein the substrate comprises a polyolefin.
4. A package or process, as defined in embodiments 1-3, wherein the chemoattractant comprises an iron containing composition.
5. A package or process, as defined in embodiments 1-3, wherein the chemoattractant comprises a mono- or di-saccharide or mixtures thereof containing composition.
6. A package or process, as defined in embodiments 1-5, wherein the antibacterial agent comprises a quaternary ammonium compound covalently bonded to the substrate layer.
7. A package or process, as defined in embodiments 1-6, wherein the antibacterial agent comprises DMOAP covalently bonded to the substrate layer.
8. A package or process, as defined in embodiments 1-5, wherein the antibacterial agent comprises silver particles or zinc pyrothione chemically bonded or mechanically held to the substrate layer.
9. A package or process, as defined in embodiments 1-8, wherein the product is a food.
10. A package or process, as defined in embodiments 1-8, wherein the product is a toiletry.
11. A package or process, as defined in embodiments 1-10, wherein the product has a water activity of at least 0.910, at least 0.930, or at least 0.970.
12. A package or process, as defined in embodiments 1-11, wherein the product has a viscosity of at least 1000 centipoise at 25° C., or a viscosity of from about 1000 to 250,000 milliPascal seconds (mPa s) at 25° C.
13. A package or process, as defined in embodiments 2-12, wherein at least 90% of its product surface area is in contact with a packaging substrate surface.

Various embodiments have been described above. Although the invention has been described with reference to these specific embodiments, the descriptions are intended to be illustrative and are not intended to be limiting. Various modifications and applications may occur to those skilled in the art without departing from the true spirit and scope of the invention as defined in the appended claims.

What is claimed is:

1. An anti-bacterial package component comprising:
a packaging substrate having an anti-bacterial agent fixed thereto; and
a bacteria attractant incorporated with said substrate and adapted for diffusion into a food or toiletry product medium;
said attractant selected from the group consisting of monosaccharides, disaccharides, polysaccharides, vitamins, minerals and amino acids;
wherein said attractant is adapted for biological transport of pathogenic or spoilage bacteria from a product medium proximate said substrate across an attractant concentration gradient to contact with said fixed anti-bacterial agent whereby said bacteria is killed, immobilized, made steril, or otherwise rendered harmless.

2. An anti-bacterial package component, as defined in claim 1, wherein said substrate comprises a polyolefin.

3. An anti-bacterial package component, as defined in claim 1, wherein said chemoattractant comprises an iron containing composition.

4. An anti-bacterial package component, as defined in claim 1, wherein said chemoattractant comprises a mono- or di-saccharide or mixtures thereof containing composition.

5. An anti-bacterial package component, as defined in claim 1, wherein said antibacterial agent comprises a quaternary ammonium compound covalently bonded to the substrate layer.

6. An anti-bacterial package component, as defined in claim 1, wherein said antibacterial agent comprises DMOAP covalently bonded to the substrate layer.

7. An anti-bacterial package component, as defined in claim 1, wherein said antibacterial agent comprises silver particles mechanically affixed to the substrate surface.

8. An anti-bacterial package component, as defined in claim 1, wherein said product is a food.

9. An anti-bacterial package component, as defined in claim 1, wherein said product is a toiletry.

10. A process comprising:
(a) providing a packaging substrate;
(b) identifying a food or toiletry product having a water activity of at least 0.910; said product being susceptible to surface contamination by bacteria and suitable for packaging with at least 50% of its product surface area proximate a packaging substrate surface;
(c) identifying a target pathogenic or spoilage bacteria;
(d) identifying a chemoattractant selected from the group consisting of monosaccharides, disaccharides, polysaccharides, vitamins, minerals and amino acids for said target bacteria; said chemoattractant being scarce in said product;
(e) identifying an antibacterial composition;
(f) fixing said antibacterial composition to a surface of said substrate in an amount effective to kill, immobilize, make steril, or otherwise render harmless said bacteria upon contact;
(g) incorporating said chemoattractant with said substrate in an amount sufficient to provide a concentration gradient in said product for inducing bacteria transport to said substrate surface.

11. A process, as defined in claim 10, wherein said substrate comprises a polyolefin.

12. A process, as defined in claim 10, wherein said chemoattractant comprises an iron containing composition.

13. A process, as defined in claim 10, wherein said chemoattractant comprises a mono- or di-saccharide or mixtures thereof containing composition.

14. A process, as defined in claim 10, wherein said antibacterial agent comprises a quaternary ammonium compound covalently bonded to the substrate layer, silver or zinc pyrothione.

15. A process, as defined in claim 10, wherein said product is food.

16. A process, as defined in claim 10, wherein said product is a toiletry.

17. A process, as defined in claim 10, wherein said water activity is at least 0.930.

18. A process, as defined in claim 10, wherein at least 90% of its product surface area in contact with a packaging substrate surface.

19. A process, as defined in claim 10, wherein said product has a viscosity of at least 1000 centipoise at 25° C.

20. A process, as defined in claim 10, wherein said product has a viscosity of from about 1000 to 250,000 milliPascal seconds (mPa s) at 25° C.
